(19) United States
(12) Patent Application Publication
(10) Pub. No.: US 2004/0020903 A1
(43) Pub. Date: Feb. 5, 2004

(54) Method for forming of perforations in a substrate and device for carrying out said method

(76) Inventors: Karst Jan van Weperen, Uden (NL); Stefan Jozef Sigfried Ruckl, Kufstein (AT); Markus Helmut Bohrer, Wien (AT)

Correspondence Address: Hoffmann & Baron, 6900 Jericho Turnpike, Syosset, NY, 11791, US

(21) Appl. No.: 10/258,837

(22) PCT Filed: Apr. 20, 2001
(86) PCT No.: PCT/NL01/00315

(30) Foreign Application Priority Data
Apr. 28, 2000 (NL) 1015044

(51) Int. Cl. B23K 9/02

(52) U.S. Cl. 219/121.36; 219/69.13

(57) ABSTRACT

The invention relates to a method for forming of perforations in a substrate, said perforations being formed by means of an intermittently operating plasmatron, the plasmatron forming an electrical discharge arc between a cathode and the substrate, and material being removed at the position where the arc strikes the substrate material, in the present case forming perforations.

The invention also relates to a device for carrying out the method, in which an intermittently operating plasmatron and the substrate are moved relative to each other in order to form a pattern of perforations in the substrate.

The invention relates in the first place to a method for treating a substrate in order to remove material selectively, in which a controlled electrical discharge arc is formed between a plasmatron and the substrate, and the setting of the plasmatron is selected in such a way that material is removed at the position where the arc strikes the substrate.

Such a method is known from U.S. Pat. No. 3,745,321, a publication which describes a method and device for cutting a material such as a metal by means of a plasmatron.

A plasmatron, as described in the abovementioned publication, comprises a source for regulating a current which serves to ignite and maintain a plasma arc burning between a cathode and an article, in the present case the substrate. A plasma-forming gas is conveyed through the cavity of an electroconductive nozzle, and under suitable current-setting conditions the nozzle delivers a plasma arc which strikes the metal to be treated, and the intensity of the arc can be set in such a way that material is removed and a cutting action is obtained.

In such plasmatrons measures are taken with the particular object of preventing considerable erosion of the outflow nozzle, and in general a current of cold gas is conveyed along the wall of the nozzle, which current thermally and electrically insulates the plasma arc column from the wall of the nozzle.

The applicant is involved in the production of perforated materials, and it has surprisingly been found that the abovementioned method for treating a substrate by means of a plasmatron can be employed for producing perforated material, to which end the method is characterized in that the plasmatron is operated intermittently in order to treat a selected substrate, and the substrate is provided with one or more perforations, and for more perforations the plasmatron and the substrate are moved relative to each other.

The procedure in this case can be as follows:

the plasmatron forms a perforation in the substrate during a period of operation;

the plasmatron and substrate are moved relative to each other until the plasmatron and a selected new location for a perforation are situated opposite each other;

the plasmatron goes into operation and forms the perforation;

the plasmatron stops, and the movement of plasmatron and substrate relative to each other is carried out until a new perforation location has been reached, and so on, until the desired perforations have been formed at the desired locations.

In an expedient method a large number of perforations with predetermined dimensions are formed, arranged in a predetermined pattern.

In a first attractive embodiment, substantially the entire surface of the substrate is provided with a pattern of perforations; in this way a material which can serve, for example, as a screen or screen-printing stencil is obtained, although many other applications are also conceivable.

In another attractive embodiment, one or more parts of the surface of the substrate is/are provided with perforations, the areas between said parts of the surface remaining unperforated.

Such a locally perforated material can serve, for example, directly as one of a series of screen-printing stencils, in the case of which each screen-printing stencil can print the pattern parts with the same selected colour and all stencils together print the total multicoloured image on, for example, a paper or textile material in web form.

In general, the perforations will expediently be arranged in a regular pattern, such as a trigonal, tetragonal or hexagonal pattern.

The method according to the invention can be carried out on any type of substrate; in particular, the substrate can be flat or cylindrical.

In the case of flat substrates an example of an application after perforation is screens or screen printing; in the case of cylindrical perforated substrates an example of an application is rotary screen printing.

It will be possible to treat many kinds of materials by means of the method according to the invention, for the purpose of forming a substrate provided with perforations; in general, very good results are obtained if the substrate is made of metal or electroconductive plastic.

Examples of metals that can be used are nickel, copper, stainless steel and phosphor bronze.

Electroconductive plastics can be formed, for example, by polyester reinforced with carbon fibres, cured epoxy resin reinforced with carbon fibres, etc.

In a special embodiment, the invention also relates to a method for producing a screen-printing stencil, in which a stencil material provided with perforations substantially over its entire surface is provided by means of known techniques with a pattern of permeable and impermeable areas and, after being provided with conventional frames, is ready for use for printing a material in web form, which method is characterized in that the stencil material is a material such as that obtained by the method described above in which a substrate is provided with perforations and the perforations extend over the entire surface of the substrate.

Such a substrate provided with perforations over its entire surface, by means of photoresist lacquer pattern-forming techniques is provided with a pattern of areas that are permeable to printing medium, in other words areas in which the photoresist lacquer has been removed, while the surrounding areas are covered by photoresist lacquer. A number of such stencils are generally produced, the permeable areas of the stencils together being able to form the multicoloured pattern on a substrate material to be printed, such as paper or textile material in web form.

The invention also relates to a method for producing a screen-printing stencil, in which a suitable substrate is provided with perforations in predetermined areas which correspond to desired permeable areas, and, after being provided with the usual frames, said substrate is ready for use for printing a material in web form, characterized in that the substrate provided with perforations is obtained by using the method according to the invention as described above, in which one or more parts of the surface of the substrate is/are provided with perforations, which perforations are arranged in a regular pattern if desired; the substrate may be flat or cylindrical, and the substrate can be selected from metals or electroconductive plastics.

Instead of the photoresist lacquer and film technique described above, a plasmatron is used in this latter case, starting directly from an unperforated substrate, to produce a perforated substrate, the perforations being formed only in those areas which have to allow through the printing medium, for example during a printing process. Here again, several stencils may be produced, in which case the stencils together can apply the total multicoloured pattern in printing medium on a material to be printed, such as a textile or paper material in web form.

The invention also relates to a device for producing a screen-printing stencil, in which a suitable substrate is provided with perforations in predetermined areas which correspond to desired permeable areas, and, after being provided with the usual frames, said substrate is ready for use for printing material in web form, characterized in that the substrate provided with perforations is obtained by using the method according to the invention as described above, in which one or more parts of a substrate is/are provided with perforations, which perforations are advantageously arranged in a regular pattern. The substrate may be flat or cylindrical and is expediently made of metal or electroconductive plastic.

The invention also relates to a device for treating a substrate in order to remove material selectively, comprising a plasmatron, substrate accommodation means for accommodating and positioning a selected substrate, means for operating the plasmatron, and means for moving plasmatron and substrate relative to each other, characterized in that the plasmatron is set for intermittent operation, and the means for moving plasmatron and substrate relative to each other are designed for forming one or more perforations in a predetermined pattern in the substrate by means of the electrical discharge arc of the plasmatron.

The invention will now be described with reference to the drawing, in which:

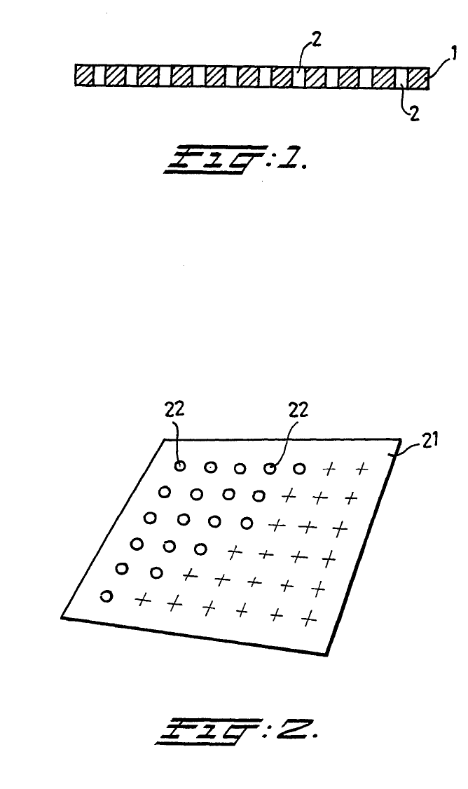

FIG. 1 represents a substrate material provided with perforations, and

FIG. 2 shows a usual pattern of perforations in a substrate material.

In FIG. 1 a substrate is indicated by 1, for example a nickel or stainless steel substrate, in which perforations 2 are formed by means of a plasmatron.

For, for example, screen or screen-printing purposes, a perforation density of 7 to 300 perforations per linear inch (=2.54 cm) is a possibility; the perforations are approximately cylindrical, and the diameter of the perforations can lie between 10 micrometres and 1 millimetre, although values differing from this are also possible.

The thickness of the substrate is, of course, dependent upon the application; in general, thicknesses between 100 and 500 micrometres are usual for screen printing or rotary screen printing, although greater or lesser thicknesses are also possible depending on the field of application.

FIG. 2 shows schematically a substrate 21 with perforations 22, which in this case are arranged in a tetragonal pattern.

1. Method for treating a substrate (1, 21) in order to remove material selectively, in which a controlled electrical discharge arc is formed between a plasmatron and the substrate (1, 21), and the setting of the plasmatron is selected in such a way that material is removed at the position where the arc strikes the substrate (1, 21), characterized in that the plasmatron is driven intermittently in order to treat a selected substrate, and the substrate (1, 21) is provided with one or more perforations (2, 22), and for more perforations (2, 22) the plasmatron and the substrate (1, 21) are moved relative to each other.

2. Method according to claim 1, characterized in that a large number of perforations (2, 22) with predetermined dimensions are formed, arranged in a predetermined pattern.

3. Method according to claim 2, characterized in that substantially the entire surface of the substrate (1, 21) is provided with a pattern of perforations.

4. Method according to claim 2, characterized in that one or more parts of the surface of the substrate (1, 21) is/are provided with perforations (2, 22).

5. Method according to claims 2-4, characterized in that the perforations (2, 22) are arranged in a regular pattern.

6. Method according to claim 1, characterized in that the substrate (1, 21) is flat or cylindrical.

7. Method according to claim 1, characterized in that the substrate (1, 21) is selected from metal and electroconductive plastics.

8. Method for producing a screen-printing stencil, in which a stencil material provided with perforations (2, 22) substantially over its entire surface is provided by means of known techniques with a pattern of permeable and impermeable areas, and, after being provided with the conventional frames, is ready for use for printing material in web form, characterized in that the stencil material is a material such as that obtained by the method according to one or more of claims 2, 3 and 5-7.

9. Method for producing a screen-printing stencil, in which a suitable substrate (1, 21) is provided with perforations (2, 22) in predetermined areas which correspond to desired permeable areas, and, after being provided with the usual frames, said substrate is ready for use for printing a material in web form, characterized in that the substrate (1, 21) provided with perforations (2, 22) is obtained by using the method according to one or more of claims 4-7.

10. Device for treating a substrate in order to remove material selectively, comprising a plasmatron, substrate accommodation means for accommodating and positioning a selected substrate (1, 21), means for operating the plasmatron, and means for moving plasmatron and substrate (1, 21) relative to each other, characterized in that the plasmatron is set for intermittent operation, and the means for moving plasmatron and substrate (1, 21) relative to each other are designed for forming one or more perforations (2, 22) in a predetermined pattern in the substrate (1, 21) by means of the electrical discharge arc of the plasmatron.
